(19) United States
(12) Patent Application Publication
(10) Pub. No.: US 2005/0051391 A1
(43) Pub. Date: Mar. 10, 2005

(54) Parking lock

(76) Inventor: Lars Severinsson, Hishult (SE)

Correspondence Address: ST. ONGE STEWARD JOHNSTON & REENS, LLC, 986 BEDFORD STREET, STAMFORD, CT, 06905-5619, US

(21) Appl. No.: 10/661,244

(22) Filed: Sep. 12, 2003

Related U.S. Application Data
(63) Continuation of application No. PCT/SE02/00459, filed on Mar. 13, 2002.

(30) Foreign Application Priority Data
Mar. 13, 2001 (SE) 0100842-4

(51) Int. Cl. B60T 13/04

(52) U.S. Cl. 188/171

(57) ABSTRACT

The present invention concerns a parking lock unit for locking a service brake actuator in an applied condition. The parking unit is primarily intended for heavy road vehicles and comprises a magnetic housing, enclosing an electromagnet and a number of jaws, which jaws are moveable in a radial direction. The park lock unit slidably receives a piston rod of a service brake actuator. The jaws and the piston rod have grooves for co-operation to lock the piston rod in an activated position. The jaws are drawn into or out of engagement with the piston rod by means of the electromagnet magnetizing the magnetic housing.

This application is a continuation of pending International Patent Application No. PCT/SE02/00459 filed on Mar. 13, 2002, which designates the United States and claims priority of pending Swedish Application No. 01008424 filed on Mar. 13, 2001.

### FIELD OF THE INVENTION

The present invention concerns a parking lock for combination with a service brake actuator for a vehicle, preferably a heavy road vehicle. The service brake actuator comprises a fluid actuated piston having a piston rod.

### BACKGROUND OF THE INVENTION

A parking braking of a vehicle may be performed by means of a parking lock, integrated in the service brake actuator to form a unit therewith. Such a unit is known for use on trucks and buses. As is well known in the art, the parking brake may for example be a so-called spring brake actuator or an actuator with fluid actuation. The fluid normally used on heavy road vehicles is compressed air, but hydraulic fluid may equally well be utilized.

A special type of parking lock is the so-called lock actuator, with which the present invention is concerned. The function of a lock actuator is to lock the service brake actuator or parts thereof in an applied condition, in such a way that the service brake actuator will stay locked even in the absence of any fluid pressure. Thus, a parking brake is obtained.

### SUMMARY OF THE INVENTION

The parking lock according to the present invention fulfils different requirements with regard to simple and reliable design, space requirement and excellent manoeuvrability. This is achieved according to the invention by a parking lock unit surrounding a piston rod of a service brake actuator. The parking lock unit comprises a magnetic housing enclosing an electromagnet and a number of jaws moveable in a radial direction.

The jaws of the parking lock unit are moved in and out of engagement with the piston rod by means of the electromagnet and a number of springs acting in a direction to urge the jaws away from or towards the piston rod.

By means of the parking lock the brakes of the vehicle may be locked in an actuated position in that grooves of the piston rod and jaws are engaged with each other. The reaction force of the brake keeps up said engagement even when the service brake actuator and the electromagnet are de-activated. A spring or the like in the brake actuator urges the brake actuator piston to resume a start position. To release the parking lock the service brake actuator has to apply a force on the piston rod, having a magnitude being enough to break the self-locking engagement between the piston rod and the jaws. In an alternative embodiment the parking lock is released by activation of the electromagnet, in addition to the force applied to the piston rod as stated above.

### BRIEF DESCRIPTION OF THE DRAWINGS

The invention will be described further below by way of an example and with reference to the drawings below. In the drawings:

FIG. 1 is a perspective view of a parking lock unit of the invention;

FIG. 2 is a perspective view of the parking lock unit of FIG. 1 taken from the opposite side;

FIG. 3 is a cross-sectional view of the parking lock unit of FIGS. 1 and 2, placed between a service brake actuator and a caliper of a disc brake or the like;

FIG. 4 is a plan view of the parking lock unit with one part broken away;

FIGS. 5 and 6 are cross sectional views taken along the line A-A in FIG. 4 and illustrating different operation positions of the parking lock unit;

FIGS. 7 and 8 are cross sectional views of an alternative embodiment of the invention, illustrating different operation positions of the parking lock unit;

FIGS. 9 and 10 are sectional views, corresponding to FIGS. 5 and 6, of a further embodiment of the invention illustrating different operation positions of the parking lock unit; and

FIGS. 11 and 12 are views corresponding to FIGS. 5 and 6 of yet another embodiment of the present invention.

### DETAILED DESCRIPTION OF A PREFERRED EMBODIMENT

The parking lock according to the invention has the form of a parking lock unit. The parking lock unit is received on a brake caliper 12. The parking lock unit is fixed to the caliper 12 by means of screws, or any other suitable fastening means. The parking lock unit comprises an outer housing 1, a rest plate 8, a magnetic housing 5, a spring 4, a cap 6, a number of jaws 7 and an electromagnet 9. The coils of the electromagnet 9 are received in a circular recess 26 in the magnetic housing 5. In the magnetic housing 5 the number of jaws 7 are received, with the cap 6 placed over the jaws 7. The spring 4 is placed between a shoulder 13 on the magnetic housing 5 and the outer housing of the parking lock unit. The spring 4 holds the cap 6 enclosing the jaws 7 on place and at the same time urges the magnetic housing 5, including the jaws 7 against an inwardly domed central part 14 of the rest plate 8.

A piston rod 2 from a service brake actuator 18 goes centrally through an opening in the rest plate 8 and the parking lock unit. The jaws 7 encircle the piston rod 2 in the parking lock unit.

The parking lock unit is slidably received on the piston rod 2 by means of plain bearings 17 or the like. In another embodiment (not shown) there are no bearings but the parking lock unit is slidably received directly on the piston rod 2. In this case the material and surfaces of the parking lock unit and the piston rod may be adapted to make the sliding possible. The. piston rod 2 is furnished with grooves 3 on the outer periphery, which grooves 3 are to co-operate with grooves 10 on the inner periphery of the jaws 7. In one embodiment (not shown) the grooves 3, 10 have the form of threads.

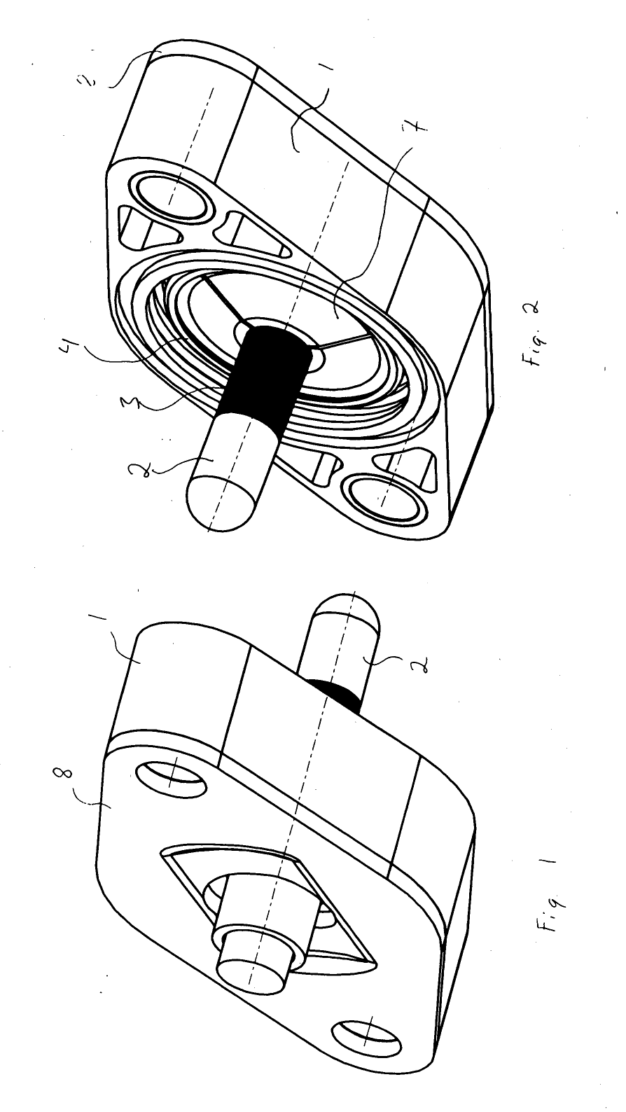

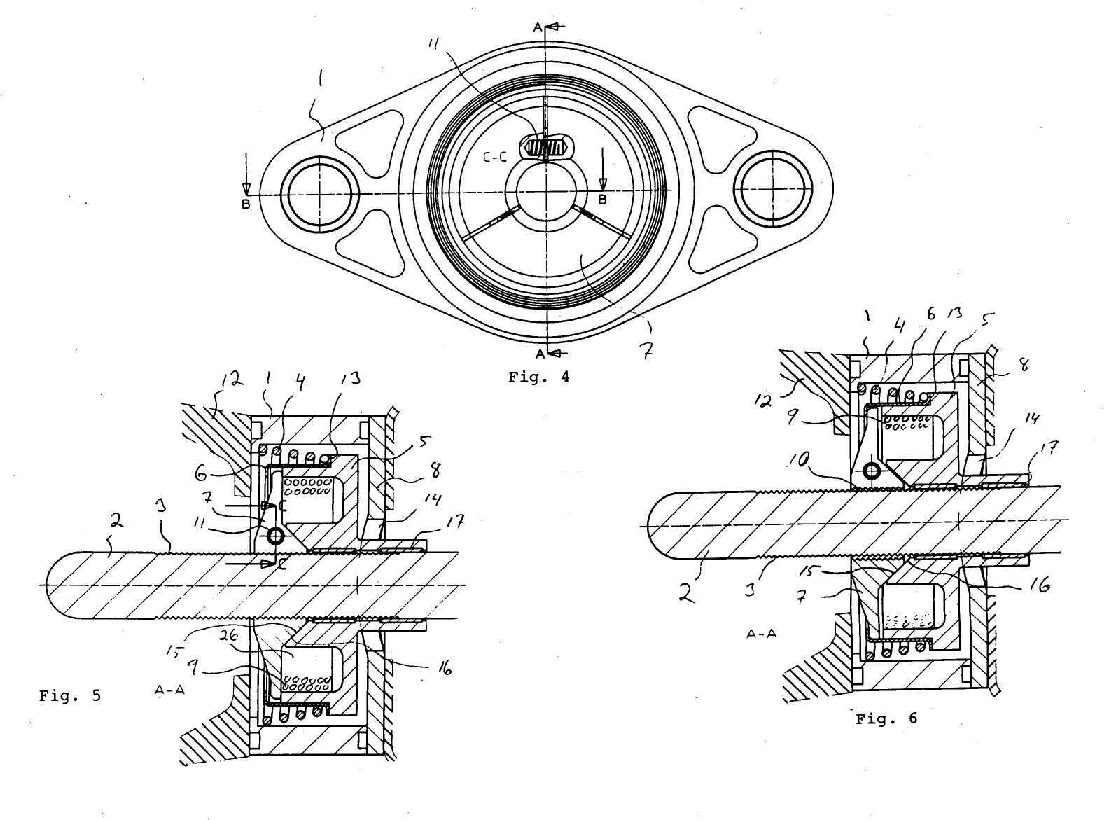

In the embodiment of FIGS. 1 to 6 the parking lock unit comprises three jaws 7, which are equally distributed to together form a ring in plan view. In other embodiments the number of jaws 7 vary. Preferably 3 to 6 jaws 7 are used. The jaws 7 are urged radially outwards by means of jaw return springs 11 placed between adjacent jaws 7. In an alternative embodiment one single, annular pressure spring placed in a groove (not shown) urges the jaws 7 outwardly. The jaws 7 together form a conical surface 15, which is in contact with a conical surface 16 of the magnetic housing 5. Movement between the jaws 7 and the magnetic housing 5 follows said conical surfaces 15, 16.

When the electromagnet 9 is energized the magnetic housing 5 will be magnetized and the jaws 7 will be drawn, against the force of the jaw return springs 11 towards the piston rod 2. Each jaw 7 will move along the conical surface 16 of the magnetic housing 5.

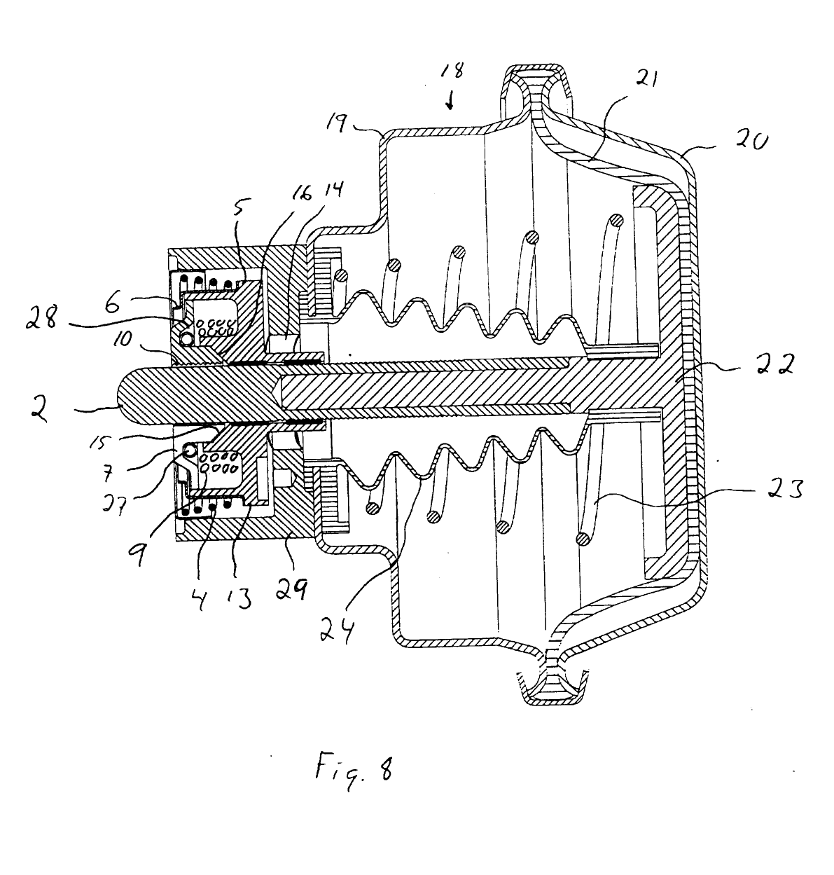

The embodiment of FIGS. 7 and 8 differs from the embodiment of FIGS. 1 to 6 described above in only some respects. The main difference is that the jaws 7 are urged inwards by means of an annular tension spring 27, received in a recess 28 of each jaw 7. A person skilled in the art realizes that the tension spring may be replaced by any means giving the same function, i.e. urging the jaws 7 towards the piston rod 2. A further difference is that the magnetic housing 5 is received in a housing 29 made in one piece. In this embodiment the domed part 14 is an integrated part of the housing 29. In addition to the above the embodiment of FIGS. 7 and 8 does not differ in any major extent from the embodiment of FIGS. 1 to 6.

Furthermore, in the embodiment of FIGS. 7 and 8 an alternative embodiment for the piston rod 2 is shown. This alternative piston rod 2 has two parts, which are axially moveable in respect to each other. The piston return spring 23 will return the diaphragm 21 to its original position, reducing the risk of harming the diaphragm 21. If the diaphragm 21 is not returned it may be held in a skewed position, due to the magnetic housing 5 being mounted in a floating way. By this alternative form for the piston rod 2, the service brake actuator is drained of air even when the parking lock is. actuated by means of the piston return spring 23. A person skilled in the art realizes that this alternative piston rod 2 may also be used in the embodiment of FIGS. 1 to 5.

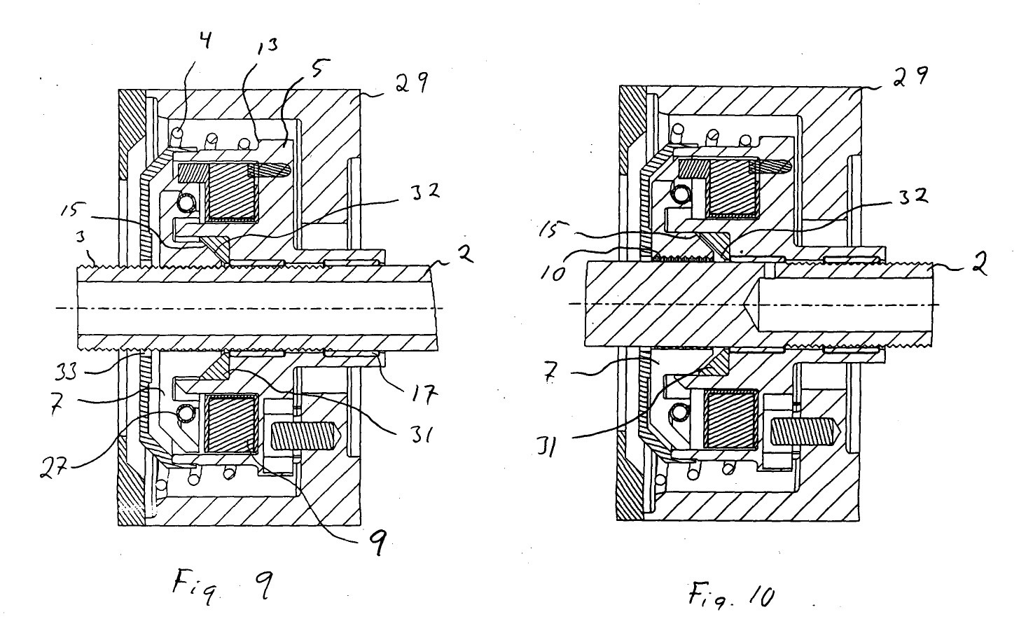

In the embodiment of FIGS. 9 and 10 a ring 31 is placed between the magnetic housing 5 and the jaws 7. The ring 31 is made of a magnetically isolating material and is used to isolate the magnetic field of the electromagnet 9. The ring 31 is received in the magnetic housing 5. The ring 31 has a conical surface 32 for co-operation with the conical surface 15 of the jaws 7. Thus, the conical surface 32 of the ring 31 has the same function as the conical surface 16 of the previous embodiments described above.

A further difference in the embodiment of FIGS. 9 and 10 is the form of the cap 30. The diameter of the central opening 33 of the ring 31 is more closely adapted to the diameter of the piston rod 2, compared to the embodiments described above. Thus, in use the cap 30 will be placed over the jaws 7 hindering a possible extensive movement of the jaws 7 in the axial direction of the piston rod 2.

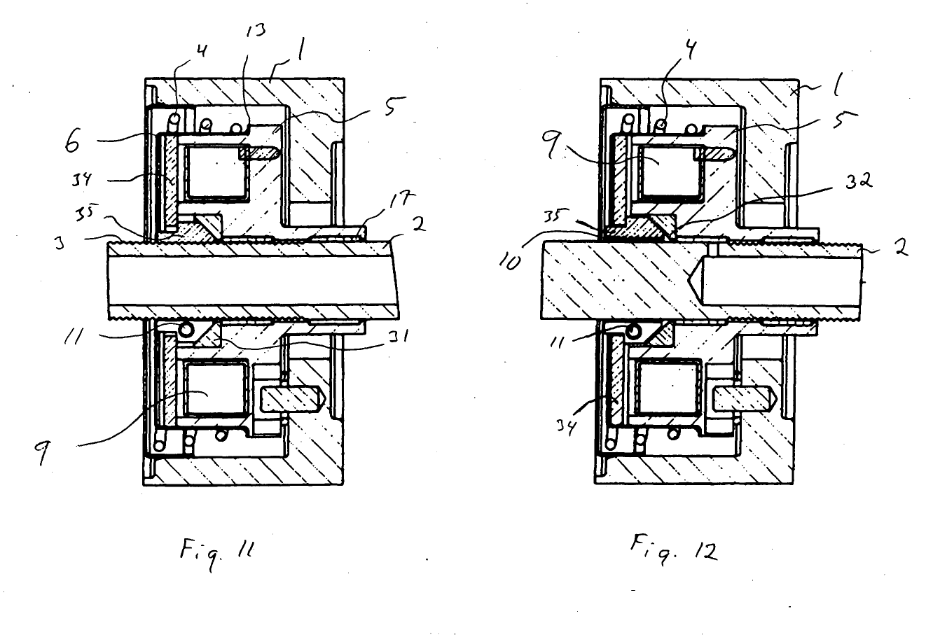

In the embodiment of FIGS. 11 and 12 the jaws 35 have a smaller radial extent compared to the above embodiments. Furthermore, said jaws 35 may be made of a non-metallic material. A plate 34 of a metallic material is placed in a recess on the jaws 35. The plate 34 has a radial extent corresponding to the position of the electromagnet 9. In use the plate 34 will be drawn towards the electromagnet 9 when it is energised. As the plate 34 is drawn towards the electromagnetic 9 it will force the jaws 35 in the same direction. Thereby the jaws will go into a locking contact with the piston rod 2, in the same way as described above for the other embodiments.

The service brake actuator 18 is conventional and is only briefly described. In housing comprising a lower part 19 and a cover part 20 there is a piston 22 and the piston rod 2, from which a pushing brake force may be delivered to further, not shown brake elements. Such brake elements may be part of a compressed air brake system for a heavy road vehicle, such as a truck or a bus.

In the shown case the service brake actuator 18 is of the diaphragm type, which means that a diaphragm 21 in contact with the piston 22 is clamped between the two housing parts 19, 20. Compressed air can be admitted to a service brake chamber at the diaphragm 21 through an inlet 25.

A piston return spring 23 is arranged between the piston 22 and the lower housing part 19. The main purpose of said piston return spring 23 is to bring the diaphragm 21 back to its starting position. A bellows 24 may be arranged between the piston rod 2 and the lower housing part 19 for protecting the interior of the parking lock unit, and a disc brake to which the parking lock may be attached.

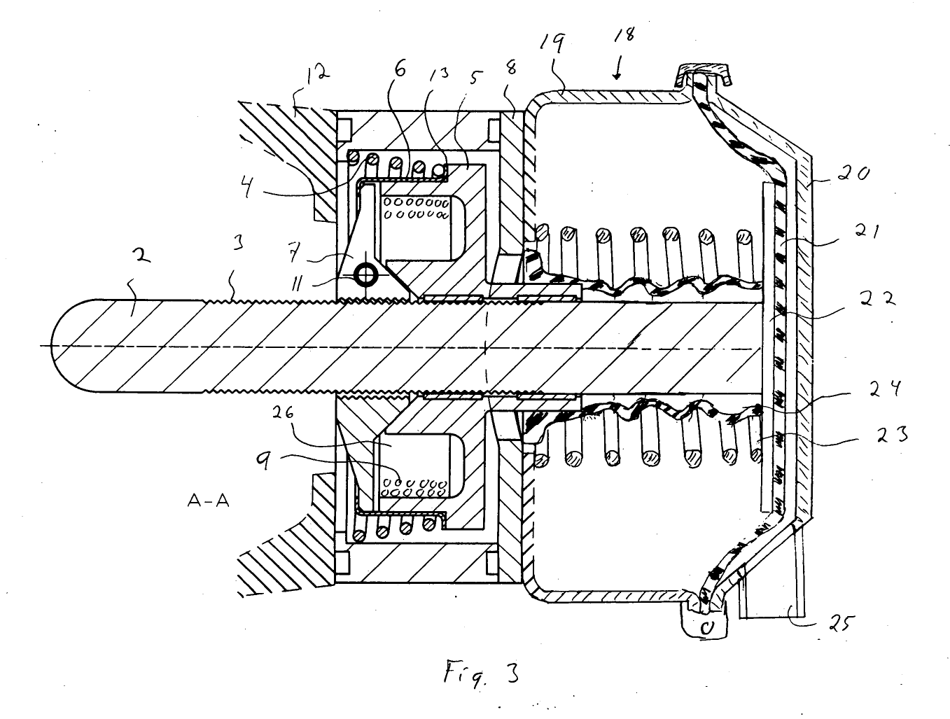

At the admission of compressed air through the inlet 25 the diaphragm 21, the piston 22 and thus the piston rod 2 will be pushed to the left as shown in the FIGS. 3, 7 and 8 for accomplishing a brake actuation in a way well known in the art. A return stroke, when the compressed air pressure is again decreased, is brought about by the reaction force of the brake.

The function of the domed part 14 is to assist in taking up any radial and angular movement caused by the lever (not shown) of the brake. The movement of the lever is rotational and this movement is transformed to a radial movement for the magnetic housing 5, which is supported in the parking lock unit in a way to take up said radial movement.

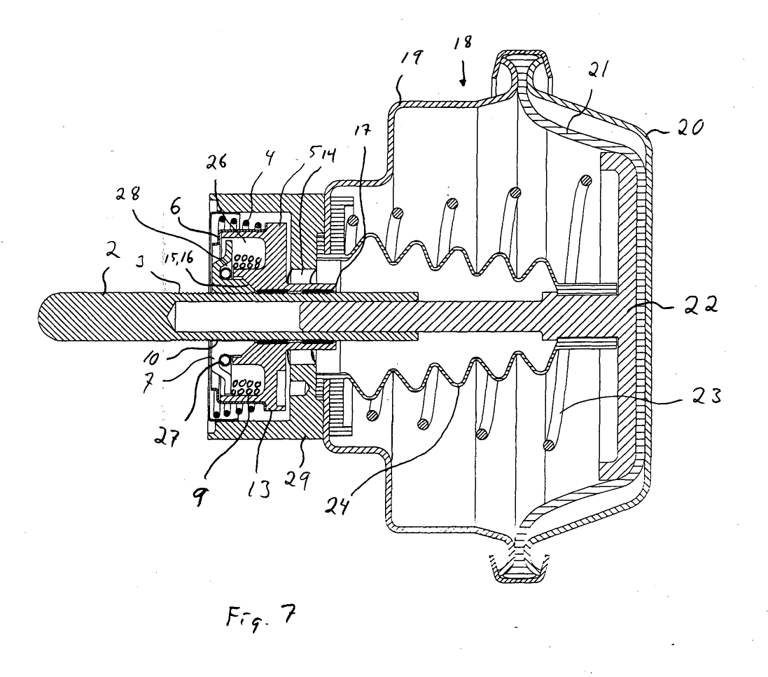

During normal use of the service brake, i.e. when the parking lock function not is utilized, the parking lock unit will glide on the piston rod 2. In the embodiments of FIGS. 1 to 6, 11 and 12 the spring 4 will hold the magnetic housing 5 against the domed part 14 of the rest plate 8. The electromagnet 9 is not energized and the jaws 7, 35 are held at a distance from the piston rod 5, by means of the jaw return springs 11. In the embodiments of FIGS. 7 to 10 the electromagnet 9 is kept energized when the parking lock function not is utilized. The energized electromagnet 9 holds the jaws 7 at a distance from the piston rod 2, against the force of the annular tension spring 27. The situation when the parking lock unit not is utilized is shown in FIGS. 6, 8, 10 and 12, respectively.

When the parking lock is to be used, the service brake is first actuated to the desired brake force. For the embodiments of FIGS. 1 to 6, 11 and 12 the electromagnet 9 is then energized, whereby the jaws 7, 35 are drawn towards the piston rod 2. In the embodiments of FIGS. 7 to 10 the function is the opposite. Thus, when the parking lock is to be used, the electromagnet 9 is de-energized, whereby the jaws 7 are drawn towards the piston rod 2 by means of the annular tension spring 27.

When the parking lock is applied the conical surfaces 15 of the jaws 7, 35 will follow the conical surface 16 of the magnetic housing 5 or the conical surface 32 of the ring 31, and the jaws 7, 35 will go inwards. As the jaws 7, 35 come into contact with the piston rod 2 the grooves 3 and 10 of the piston rod 2 and jaws 7, 35, respectively, will go into contact with each other. Hereby, the jaws 7, 35 of the parking lock unit will be locked to the piston rod 2 hindering movement of the piston rod 2. A person skilled in the art realises that any other means giving a substantial friction between the jaws 7, 35 and the piston rod 2 may be used in stead of the grooves 3, 10. The reaction force of the brake will urge the piston rod 2 to the right in FIG. 3 supporting the engagement between piston rod 2 and jaws 7, 35. The engagement between the grooves 3, 10 of the piston rod 5 and the jaws 7, 35, respectively is a self-locking engagement supported by the reaction force of the brake. If and when the service brake is inactivated the brake force will remain, due to the engagement between the jaws 7, 35 and the piston rod 2. The piston rod 2, or the part of the piston rod 2 in contact with the jaws 7, 35, is hindered from moving. When the service brake actuator 18 has been inactivated the parking lock will still be activated, even if the electromagnet 9 is de-energized in the embodiments of FIGS. 1 to 6, 11 and 12. In the embodiments of FIGS. 7 to 10 the annular tension spring 27 will support the reaction force of the brake in keeping the parking lock activated. In FIGS. 5, 7, 9 and 11, respectively, the parking lock unit is shown in an activated state.

To inactivate the parking lock in the embodiments of FIGS. 1 to 6, 11 and 12 the service brake is actuate with a braking force being somewhat bigger than the braking force of the parking lock. The service brake is actuated by means of the service brake actuator 18 as stated above. Hereby, the grooves 10 of the jaws 7, 35 will be released from the grooves 3 of the piston rod 2. The jaws 7, 35 will then be urged radially outwards by means of the jaw return springs 11 arranged between adjacent jaws 7, 35.

To inactivate the parking lock in the embodiment of FIGS. 7 to 10 the electromagnet 9 is energized. The energized electromagnet 9 will draw the jaws 7 from the piston rod 2 against the force of the annular tension spring 27.

The jaws 7, 35 and their co-operation with the piston rod 2 form a self-locking mechanism. It is self-locking in that sense that it stays locked after it has been applied, thus, the magnet 9 is only used to activate the locking mechanism. A person skilled in the art realises that any type of self-locking mechanism fulfilling these criteria may be used. E.g. it is possible to use balls received in grooves, spring and pin arrangements etc.

A person skilled in the art realises that the parts differing between the shown embodiments may be combined in any suitable combination.

1. A parking lock for a brake of a vehicle, preferably a heavy road vehicle, which parking lock has the form of a unit surrounding a piston rod of a service brake actuator, which parking lock unit comprises an electrically actuated locking means, characterized in that the parking lock unit comprises a magnetic housing, enclosing an electromagnet and a number of jaws, moveable in a radial direction in the parking lock unit:

2. The parking lock of claim 1, characterized in that the locking means is self-locking.

3. The parking lock of claim 1, characterized in that the piston rod is received in a central opening of the parking lock unit and that the piston rod is axially moveable in relation to the parking lock unit.

4. The parking lock of claim 3, characterized in that the jaws received in the magnetic housing form a ring surrounding the piston rod.

5. The parking lock of claim 4, characterized in that a ring is received in the magnetic housing, which ring is made of a magnetically isolating material and is facing the jaws and/or that each jaw has a conical surface for co-operation with a conical surface of the magnetic housing or a conical surface of the ring.

6. The parking lock of claim 5, characterized in that coils forming the electromagnet are received in a circular recess in the magnetic housing.

7. The parking lock of claim 6, characterized in that the jaws have grooves on the side turned towards the piston rod and that the piston rod has grooves on the outer periphery and in the area for the parking lock unit and/or that the magnetic housing and the jaws are made of a magnetic material.

8. The parking lock of claim 7, characterized in that the grooves of the piston rod and the jaws respectively, have the form of threads.

9. The parking lock of claim 8, characterized in that the parking lock unit comprises three to six jaws and preferably three jaws evenly distributed around the piston rod.

10. The parking lock of claim 9, characterized in that jaw return springs are placed between adjacent jaws to urge the jaws radially outwards.

11. The parking lock of claim 10, characterized in that an annular tension spring is arranged to urge the jaws radially inwards.

12. The parking lock of claim 11, characterized in that the magnetic housing is urged against a domed part by means of a spring, which is acting between a shoulder of the magnetic housing and an outer housing of the parking lock unit, whereby any radial movement of the piston rod, caused by a lever of the brake acting on the piston rod, is taken up by movement between the magnetic housing and the domed part.

13. The parking lock of claim 12, characterized in that a plate of a magnetic material is placed in a recess on the jaws and that the plate has a radial extent corresponding to the position of the electromagnet.

14. The parking lock of claim 13, characterized in that the piston rod is formed of two parts, which are axially moveable in respect of each other, and whereby one of the parts of the piston rod is free to move axially even if the other part is locked by the parking lock.
